(19) United States
(12) Patent Application Publication
(10) Pub. No.: US 2003/0174139 A1
(43) Pub. Date: Sep. 18, 2003

(54) Method for communicating with an operating device for lamps

(75) Inventors: Andreas Huber, Maisach (DE); Bernhard Reiter, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHL, MUNCHEN (DE)

(21) Appl. No.: 10/385,836

(22) Filed: Mar. 12, 2003

(30) Foreign Application Priority Data
Mar. 12, 2002 (DE) 10210716.5

(51) Int. Cl. G09G 5/37

(52) U.S. Cl. 345/561

(57) ABSTRACT

The invention relates to a communication method for exchanging data between an operating device for a light source and a control device in the case of equipment for projecting images. Simple signals present are used to transmit complex information. The information is imaged in this case by the pulse duration or the amplitude of the signals.

### TECHNICAL FIELD

The invention proceeds from communication methods in accordance with the preamble of claim 1. It relates, in particular, to communication methods for exchanging data between an operating device for a light source and a control device in the case of equipment for projecting images.

### BACKGROUND ART

The following components are to be found in equipment that serves for projecting pictorial contents and is termed projectors below:

An optical imaging system with a light source,

An operating device that supplies the light source with energy,

A light modulation unit that impresses the pictorial information to be displayed onto the light emanating from the light source,

A control unit having the following tasks:

to condition pictorial information fed to the projector in a way suitable for the light modulation unit and feed it to the latter

to control and monitor the operating device.

Examples of such projectors are back projection devices that are used in large format television devices, or so-called beamers that mostly serve to display information supplied by computers.

Two competing systems currently prevail for the light modulation unit. One is based on liquid crystal technology (LCD), while the other consists of a matrix of micromirrors (DLP) that can be addressed and can be tilted by electric signals. The costs for both light modulation units set forth rise disproportionately with the area of the light modulation unit, for which reason an attempt is being made to keep these as low as possible. This gives rise to demands placed on the optical system, particularly on the light source. The light source is to be as punctiform as possible and to have the highest possible luminous density. In order to be able to meet these requirements, use is chiefly being made of very high pressure discharge lamps with a short arc length.

Such lamps are operated as a rule with a rectangular current whose fundamental frequency is between 50 Hz and 1 kHz. The polarity reversal of this lamp current at the rectangular edges is termed commutation below. The requirement for light that is as uniform as possible can be met only conditionally in the commutation, for which reason an attempt is made to locate the commutation at an instant that is not critical in the temporal variation in pictorial information. This presupposes that there takes place between operating device and control device a communication in which the control device conveys to the operating device a synchronization signal that triggers a commutation. If the projector includes a so-called color wheel that controls the temporal sequence of the projection of different colors, it is preferred to carry out a commutation during a color transition.

In conventional nonreflecting, but transmitting light modulation units using LCD technology, an above named synchronization is mostly not sensible, since the projection of different colors is performed not sequentially but in parallel and so no temporal color transition takes place. In the case of projectors that operate using this technology, the communication from the control device to the operating device is used merely to switch the operating device on and off. This switching signal is also termed synchronization signal below for the purpose of a generic representation.

The control device is sensitive to electric disturbances and may include touchable parts, while by comparison with the control device the operating device produces high currents and voltage and is generally connected to a system voltage. Consequently, for communication between operating device and control device use is made in the prior art of optocouplers that satisfy so-called SELV (Safety Extra Low Voltage) requirements. Of their very nature, optocouplers are less suitable for analogue signal transmission, for which reason preference is given to digital communication between operating device and control device.

The conveyance of the synchronization signal requires a communication from the control device in the direction of the operating device. Communication in the opposite direction is also known in the prior art. What is concerned in this case is a so-called lamp lit signal with the aid of which the operating device merely informs the control device that the lamp is burning.

One optocoupler each is required for transmitting the lamp lit signal and the synchronization signal. According to the prior art, only said signals are transmitted via these optocouplers. However, it would be desirable to communicate further information. Firstly, the control device requires substantially more information than only the one bit of information as to whether the lamp is burning or not, for example information about the power being consumed by the lamp. Secondly, the control device requires more intervention options in the operating device than only the synchronization described, for example the prescription of a lamp power. It is known from the prior art to use a third optocoupler via which information can be transmitted from the control device to the operating device. This third optocoupler not only raises the outlay and the costs for a projector under discussion, but also increases the geometric dimensions of the components that are to be accommodated in the projector housing. This aspect is becoming ever more important with advancing miniaturization of the projectors.

### DISCLOSURE OF THE INVENTION

It is an object of the present invention to provide a method for the communication of a control unit with an operating device for lamps, to which device the control unit cyclically feeds a synchronization signal, having the following method steps:

detection of an edge of the synchronization signal by the operating device, waiting for a prescribed waiting time, and then evaluating the level of an information signal.

The method should be accomplished with low outlay.

Particularly advantageous refinements are to be found in the dependent claims.

The invention is based on the fact that the two abovenamed optocouplers for transmitting the synchronization signal and the lamp lit signal that are present in any case are used in order to transmit additional information. As a result, there is advantageously no need for additional outlay on hardware. Since the projectors under discussion are generally controlled by the software of built-in microcontrollers, it is possible to implement the invention purely by a change in software in a projector according to the prior art.

As described above, the synchronization signal is transmitted from the control unit to the operating device via an optocoupler. The actual information for the synchronization of the commutation is generally in the rising edge of the synchronization signal. According to the invention, the duration of the synchronization signal is used in order to transmit further information to the operating device.

The first step in detecting information content in the way according to the invention during the communication between operating device and control unit is to detect the rising edge of the synchronization signal. If detection takes place, a wait timer is started which, after a permanently set waiting time, causes the read out of the level of that signal whose information content is to be detected.

In the case of the communication from the control unit to the operating device, the information content is in the synchronization signal, according to the invention. After the detection of the rising edge thereof, the wait timer is used to wait for a prescribed waiting time. After the expiry of the waiting time, an evaluation instant is reached and the level of the synchronization signal is evaluated. The level of the synchronization signal can assume two values that correspond respectively to a high level or a low level. After the rising edge, the synchronization signal is at high level. According to the invention, the information to be transmitted from the control unit to the operating device is contained in the duration at which the synchronization signal persists at high level. Since, as set forth above, this is digital information, said duration assumes either an H value or an L value. The H value can then be assigned to the transmission of a logic 1, and the L value to the transmission of a logic 0. Without limitation of generality, it is assumed below that the H value is shorter than the L value. According to the invention, a value is selected for the waiting time that lies between the H value and the L value. If a high level is now established when evaluating the synchronization signal at the evaluation instant, the duration of the synchronization signal has therefore assumed the L value in accordance with the above definition, and so a logic 0 has been transmitted to the operating device. If a low level is established when evaluating the synchronization signal at the evaluation instant, the duration of the synchronization signal has assumed the H value, and a logic 1 has been transmitted. The transmission of a bit from the control unit to the operating device is therefore terminated and the operating device waits until the next rising edge of the synchronization signal is detected.

The idea of the invention is not connected with the abovenamed level definitions. However, it is also possible to implement the invention by providing that all the levels are inverted and a detection of the falling edge of the synchronization signal takes place.

The communication method according to the invention is not limited to the transmission of isolated bits. However, it possible for a plurality of serially transmitted bits to be combined to form a so-called word. For example, in a way similar to the RS232 Standard, one byte can be transmitted by the transmission of a start bit followed by 8 bits and a stop bit.

The transmission of information from the operating device to the control unit is performed via a second optocoupler that is provided in the prior art for transmitting the lamp lit signal. As in the case of the transmission of information from the control unit to the operating device, according to the invention the transmission of information from the operating device to the control unit also operates synchronously with the rising edge of the synchronization signal. The operating device firstly detects the rising edge of the synchronization signal. If a detection takes place, a transmit timer is started in the operating device, and a receive timer is started in the control unit. The control unit does not require a detector for detecting the rising edge of the synchronization signal, since it triggers the emission of a synchronization signal itself. After expiry of the transmit timer, the operating device puts the lamp lit signal at a level corresponding to the information to be transmitted. After expiry of the receive timer, the control unit evaluates the lamp lit signal. As in the case of the synchronization signal, the level of the lamp lit signal can also assume two values that correspond respectively to a high level or a low level, which are in turn assigned to a logic 1 or a logic 0. After the evaluation of the lamp lit signal by the control unit, one bit is transmitted from the operating device to the control unit. The transmission of a further bit is triggered by the next rising edge of the synchronizations signal.

The abovenamed transmit timer can be saved if no waiting time is required for emitting a bit by the lamp lit signal. In this case, the lamp lit signal is put at the level corresponding to the information to be transmitted directly after detection of the rising edge of the synchronization signal. In this case, on the part of the control unit the receive timer is used purely to wait for propagation times for the transmission of information, and the lamp lit signal is then evaluated.

As in the case of the transmission from the control unit to the operating device, the method for communication according to the invention is also not limited in the other direction to the transmission of isolated bits. However, it also possible here for a plurality of serially transmitted bits to be combined to form a word. For example, in a way similar to the RS232 Standard, one byte can be transmitted by the transmission of a start bit followed by 8 bits and a stop bit.

The following advantage according to the invention is to be emphasized in the context of the transmission from the operating device to the control unit: the transmission runs synchronously without the need to provide a time base in the operating device. According to the invention, the synchronization signal output by the control unit supplies the time base for the transmission both from the control unit to the operating device and in the opposite direction. The communication method according to the invention is particularly advantageous for a transmission from the operating device to the control unit that runs synchronously with the synchronization signal, since the synchronization signal does not generally have a fixed period. However, sequential temporal spacings of the rising edges of the synchronization signal are different.

Numerous information contents are conceivable for transmission in a projector in which the described communication method is applied. For example, current lamp performance quantities such as the lamp power can be conveyed from the operating device to the control unit. On the other hand, the control unit can convey to the operating device which type of performance quantity is to be conveyed, or which value the magnitude desired for the lamp power is to assume. These examples show that it is advantageous that the flow of information is directed not only from the control unit to the operating device or from the operating device to the control unit. According to the invention, it is not only that the information content of the synchronization signal or of the lamp lit signal is evaluated, but that both signals contain information that is evaluated.

A further application is switching the operating device on and off. This has already been described above for the case of the transmitting LCDs. No commutation synchronous with the synchronization signal is required in the case of this application. With the aid of the communication method according to the invention, the control unit can convey to the operating device an instruction sequence that cancels the coupling between commutation and synchronization signal.

Further applications are the conveyance of information about temperatures in the operating device, software version, serial number of a microcontroller or instructions relating to operating modes such as economy mode, or to selection of a software version.

A flexibility enabling costly hardware changes to be avoided in many instances is possible in a projector with the aid of the communication method according to the invention.

### BRIEF DESCRIPTION OF THE DRAWINGS

The invention is to be explained below in more detail with the aid of an exemplary embodiment and with reference to drawings, in which:

FIG. 1 shows the time profile of a synchronization and lamp lit signal according to the invention,

FIG. 2 shows the time profile of a synchronization signal according to the invention for transmitting one byte.

### BEST MODE FOR CARRYING OUT THE INVENTION

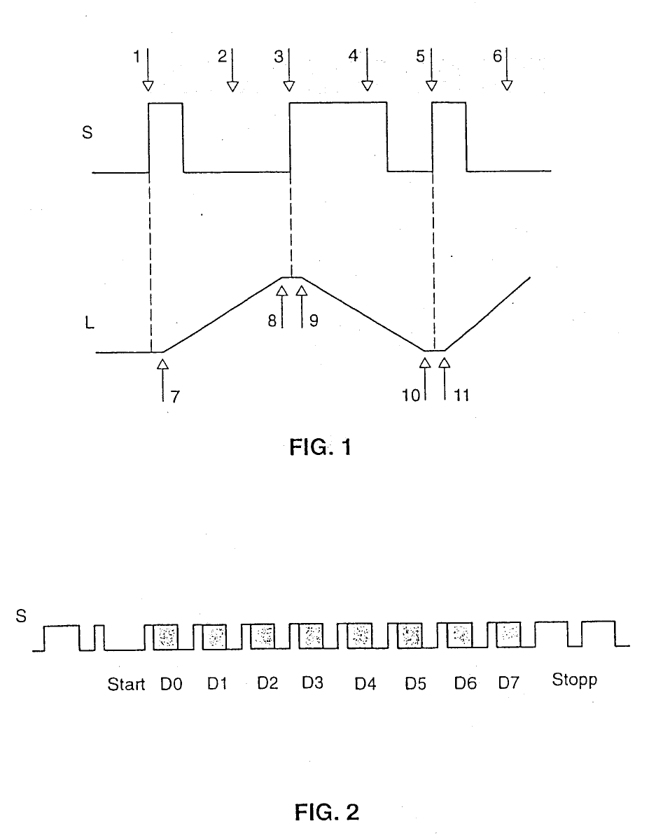

The time profile of a synchronization signal S and lamp lit signal L according to the invention is illustrated in FIG. 1. Instants 1 to 11 are marked by arrows.

The first step is to explain the profile of the synchronization signal S. At instant 1, the synchronization signal S has a rising edge from a low level to a high level, that is detected by the operating device. At the same time, the operating device starts a wait timer that is set to a waiting time. At instant 2, the waiting time has expired. According to the invention, the duration at which the synchronization signal S sent by the control unit persists at the high level can assume only two values, specifically an H value or an L value. The waiting time is selected such that it lies between these values. The synchronization signal S is evaluated at instant 2. In the example illustrated in FIG. 1, the operating device establishes at instant 2 a synchronization S that has fallen again to low level. The duration of the high level can be derived therefrom. If the definitions presented by way of example in the description of the invention are assumed, the operating device detects at instant 2 that the control unit has transmitted a logic 1.

At instant 3, the synchronization signal S again has a rising edge, which is detected by the operating device. After the waiting time, the operating device evaluates the level of the synchronization signal S at instant 4. This time, the synchronization signal S persists longer at the high level than after the rising edge at instant 1. Consequently, the operating device detects at instant 4 that the synchronization signal S still has high level, and thus that a logic 0 has been transmitted.

At instant 5, the operating device detects the next rising edge. In the present example, after the waiting time the operating device detects at instant 6 that the control unit has transmitted a logic 1. After instant 6, the operating device waits until it detects the next rising edge of the synchronization signal S, and the transmission of further bits is repeated cyclically.

The time profile of a lamp lit signal L is illustrated by way of example below the synchronization signal S in FIG. 1. Dashed lines are intended to explain the temporal relationship between the two signals. According to the above exposition of the invention, after the rising edge a receive timer is started in the control unit and a transmit timer is started in the operating device. After expiry of the transmit timer, the operating device outputs a lamp lit signal L at a level corresponding to the desired information. After expiry of the receive timer, the control unit evaluates the lamp lit signal L. The transmit and receive timers are tuned to one another in such a way that at the instant where the control unit evaluates the lamp lit signal L, a level valid in accordance with the information to be transmitted is present at the lamp lit signal L.

In the present example, the transmit timer started at instant 1 has expired at instant 7. From this instant, the operating device starts to set the level of the lamp lit signal L in accordance with the next item of information to be transmitted. The time up to the expiry of the receive timer is available for this purpose to the operating device. In the present example, the control unit always evaluates the lamp lit signal L simultaneously with the rising edge of the synchronization signal S. The task of the receive timer can thereby advantageously be taken over at least in part by devices present in the control device for generating the synchronization signal S. Therefore, in the present case, the operating device has at most the time up to the next rising edge of the synchronization signal S in order to set a valid level for the next bit to be transmitted. It may be gathered from the profile of the lamp lit signal L that the signal has reached a high level starting from instant 8. This happens in good time before it is evaluated at instant 3 by the control device. The assignment of the high level present at instant 3 to a logic 0 or 1 can be selected arbitrarily. Before instant 3, the lamp lit signal L has been evaluated at instant 1 when a low level is present. After the high level at instant 3, the lamp lit signal L is evaluated at instant 5, when in accordance with FIG. 1 a low level is present again. With reference in each case to the rising edges of the synchronization signal (instants 1, 3 and 5), the transmit timer is started in the operating device and runs to instants 7, 9 and 11. The run time of the transmit timer need only last until the control device has evaluated the lamp lit signal L. By comparison with an entire cycle time, this can happen very quickly between two rising edges. A microcontroller for which in some circumstances a few instruction cycles suffice to implement the run time required for the transmit timer is suggested for implementing the communication method according to the invention. The profile of the lamp lit signal L between instants 7 and 8 and instants 9 and 10 is arbitrary. It need only be ensured that a valid level is reached at the evaluation instants 1, 3 and 5. This is the case in the example starting from instants 8 and 10.

Illustrated in FIG. 2 is a lengthy time profile of a synchronization signal S in which one byte of information is transmitted. The transmission is initiated by a starting bit marked by Start that is implemented by means of a short synchronization signal pulse. Eight data bits D0 to D7 follow thereafter. Hatching indicates that the data bits can be short or long depending on the information content. After the last data bit D7, the transmission of the byte is terminated by a long stop bit marked by Stopp.

1. A method for the communication of a control unit with an operating device for lamps, to which device the control unit cyclically feeds a synchronization signal, having the following method steps:
detection of an edge of the synchronization signal by the operating device,
waiting for a prescribed waiting time,
evaluating the level of an information signal.

2. The method as claimed in claim 1, wherein the synchronization signal is evaluated as information signal.

3. The method for communicating with an operating device for lamps as claimed in claim 2, wherein the duration of the synchronization signal can assume an L value and an H value, and the operating device evaluates the synchronization signal at an evaluation instant that lies between the L value and the H value after detection of the rising edge of the synchronization signal.

4. The method for communicating with an operating device for lamps as claimed in claim 1, wherein a lamp lit signal that is generated by the operating device is evaluated as information signal.

5. The method for communicating with an operating device for lamps as claimed in claim 4, wherein the lamp lit signal is evaluated by the control unit at the same time as the rising edge of the synchronization signal.

6. The method for communicating with an operating device for lamps as claimed in claim 1, wherein the level of two information signals is evaluated, the synchronization signal and a lamp lit signal that is generated by the operating device forming the information signals.

7. The method for communicating with an operating device for lamps as claimed in one of the preceding claims, wherein a cycle time with which the synchronization signal is cyclically repeated assumes different values.

8. A device that is suitable for projecting pictorial contents and has the following features:
a light source,
an operating device that supplies the light source with energy,
a control unit that controls the operating device, wherein a communication method as claimed in one of the preceding claims runs between operating device and control unit.
